(19) United States
(12) Patent Application Publication
(10) Pub. No.: US 2014/0332731 A1
(43) Pub. Date: Nov. 13, 2014

(54) Electrode Composition for Battery

(71) Applicant: CNano Technology Limited, San Francisco, CA (US)

(72) Inventors: Jun Ma, Irvine, CA (US); Yan Zhang, Beijing (CN); Caihong Xing, Beijing (CN); Ou Mao, Mequon, WI (US)

(21) Appl. No.: 14/338,325

(22) Filed: Jul. 22, 2014

Related U.S. Application Data
(63) Continuation-in-part of application No. 13/437,205, filed on Apr. 2, 2012.

(51) Int. Cl. H01M 4/525; H01M 4/62; H01M 4/58

(52) U.S. Cl. CPC H01M 4/525; H01M 4/5825; H01M 4/623; H01M 4/625
USPC 252/506

(57) ABSTRACT

Carbon nanotube-based compositions and methods of making an electrode for a battery are disclosed. It is an objective of the instant invention to disclose a composition for an electrode of a battery incorporating three dimensional networks of carbonaceous materials comprising a bi-modal diameter distribution of carbon nanotubes, CNT(A) and CNT(B), graphene, carbon black and, optionally, other forms of carbon-based pastes.

### PRIORITY

This application is a continuation-in-part and claims priority from U.S. application Ser. No. 13/437,205 filed on Apr. 2, 2012 and which is incorporated herein in its entirety by reference.

### CROSS-REFERENCE TO RELATED APPLICATIONS

This application is related to U.S. Pat. No. 7,563,427, U.S. 2009/0208708, 2009/0286675; U.S. Pat. No. 12/516,166; U.S. application Ser. Nos. 13/006,266, and 13/006,321 filed on Jan. 13, 2011 and U.S. application Ser. No. 13/285,243, filed on Oct. 31, 2011; all incorporated herein in their entirety by reference.

### BACKGROUND OF THE INVENTION

1. Field of the Invention

The present disclosure relates to three dimensional networks of carbonaceous materials comprising CNT(A), CNT(B), graphene, carbon black and, optionally, other forms of carbon-based pastes, compositions of carbon enhanced electrodes, and methods of making electrodes for a battery.

Carbon nanotubes (CNT) have many unique properties stemming from small sizes, cylindrical graphitic structure, and high aspect ratios. A single-walled carbon nanotube (SWCNT) consists of a single graphite, or graphene, sheet wrapped around to form a cylindrical tube. A multiwall carbon nanotube (MWCNT) includes a set of concentrically single layered nanotube placed along the fiber axis with interstitial distance of 0.34 nanometers. Carbon nanotubes have extremely high tensile strength (˜150 GPa), high modulus (˜1 TPa), good chemical and environmental stability, and high thermal and electrical conductivity. Carbon nanotubes have found many applications, including the preparation of conductive, electromagnetic and microwave absorbing and high-strength composites, fibers, sensors, field emission displays, inks, energy storage and energy conversion devices, radiation sources and nanometer-sized semiconductor devices, probes, and interconnects, etc. Carbon nanotubes are often characterized according to tube diameters. Materials possessing smaller diameters exhibit more surface area and fiber strength; larger diameter nanotubes have a smaller surface area to volume ratio, and the surface area is more accessible than smaller nanotubes due to less entanglement. In addition, large diameter nanotubes are often straighter compared to smaller ones; thus large diameter nanotubes extend through more space or volume in a composite matrix.

Carbon nanotubes possess outstanding material properties but are difficult to process and insoluble in most solvents. Historically polymers such as poly(vinylpyrrolidone) (PVP), poly(styrene sulfonate) (PSS), poly(phenylacetylene) (PAA), poly(meta-phenylenevinylene) (PmPV), polypyrrole (PPy), poly(p-phenylene benzobisoxazole) (PBO) and natural polymers have been used to wrap or coat carbon nanotubes and render them soluble in water or organic solvents. Previous work also reports single-walled carbon nanotubes (SWCNTs) have been dispersed with three types of amphiphilic materials in aqueous solutions: (i) an anionic aliphatic surfactant, sodium dodecyl sulfate (SDS), (ii) a cyclic lipopeptide biosurfactant, surfactin, and (iii) a water-soluble polymer, polyvinylpyrrolidone (PVP).

Conventional electro-conductive pastes or inks are comprised primarily of polymeric binders which contain or have mixed in lesser amounts of electro-conductive filler such as finely divided particles of metal such as silver, gold, copper, nickel, palladium or platinum and/or carbonaceous materials like carbon black or graphite, and a liquid vehicle. A polymeric binder may attach the conductive filler to a substrate and/or hold the electro-conductive filler in a conductive pattern which serves as a conductive circuit. The liquid vehicle includes solvents (e.g., liquids which dissolve the solid components) as well as non-solvents (e.g., liquids which do not dissolve the solid components). The liquid vehicle serves as a carrier to help apply or deposit the polymeric binder and electro-conductive filler onto certain substrates. An electro-conductive paste with carbon nanotubes dispersed within is a versatile material wherein carbon nanotubes form low resistance conductive networks.

2. Background

Background and supporting technical information is found in the following references, all incorporated in their entirety herein by reference; U.S. Pat. No. 4,427,820, U.S. Pat. No. 5,098,711, U.S. Pat. No. 6,528,211, U.S. Pat. No. 6,703,163, U.S. Pat. No. 7,008,563, U.S. Pat. No. 7,029,794, U.S. Pat. No. 7,365,100, U.S. Pat. No. 7,563,427, U.S. Pat. No. 7,608,362, U.S. Pat. No. 7,682,590, U.S. Pat. No. 7,682,750, U.S. Pat. No. 7,781,103, U.S.2004/0038251, U.S.2007/0224106, U.S.2008/0038635, U.S.2009/0208708, U.S.2009/0286675, U.S.2010/0021819, U.S.20100273050, U.S.2010/0026324, U.S.2010/0123079, 2010/0143798, 2010/0176337, U.S.2010/0300183, U.S.2011/0006461, U.S.2011/0230672, U.S.2011/0171371, U.S.2011/0171364; U.S.2014/0045065; U.S.2014/0079991; U.S.2014/0154577.

### BRIEF SUMMARY OF THE INVENTION

Carbon nanotube-based compositions and methods of making an electrode for a battery, optionally a Li ion battery, are disclosed. It is an objective of the instant invention to disclose a composition for preparing an electrode of a lithium ion battery with incorporation of carbon nanotubes with more active material by having less conductive filler loading and less binder loading such that battery performance is enhanced. In one embodiment an enhanced electrode composition uses less binder, such as PVDF, thus allowing more electrode material, absolutely and proportionately, by weight, in the composition, which in-turn improves overall storage capacity. It is an objective of the instant invention to disclose a composition for preparing a cathode or anode of lithium ion battery with incorporation of carbon nanotubes such that enhanced battery performance by having less conductive filler loading, less binder loading and more active material.

The instant invention discloses that carbon nanotubes with a combination of large and small diameters, optionally, in combination with other forms of carbon, are used to accommodate different cathode or anode materials of variable sizes. Generally, cathode and/or anode materials with smaller particle sizes tend to have less pore size under compression, while large particles have more pore volume. Small diameter carbon nanotubes fit in the small space between small cathode and/or anode particles. When large diameter particles exist in an electrode, small diameter nanotubes do not easily fill the Combinations of large and small carbon nanotubes, optionally, in combination with other forms of carbon, provide solutions for dealing with various cathode and anode materials of different particle sizes. The ratio of large to small diameter nanotubes depends upon the selection of cathode and/or anode materials, e.g. size, electrical property, etc., and the compression force used to bring all materials together on a current collector.

As described in U.S. Provisional 61/294,537, a conductive paste based on carbon nanotubes is comprised of carbon nanotubes and preferred amount of liquid vehicle as dispersant and/or binder. During investigation, it was surprisingly found that combinations with other forms of carbon, such as CNT, graphene and carbon black,in various weight ratios can further reduce binder loading requirements.

### BRIEF DESCRIPTION OF THE SEVERAL VIEWS OF THE DRAWING(S)

FIG. 1A illustrates a schematic diagram of coating made of active materials, carbon nanotubes and binder on an aluminum film as an electrode of lithium battery. FIGS. 1B and 1C illustrate both large and small cathode and/or anode particles in an electrode layer.

FIG. 2 illustrates a cycle performance of lithium ion battery comprising carbon nanotubes.

FIG. 3 shows the conductive network formed by CNT coating on LiFePO₄ observed under scanning electron microscope (SEM)

FIG. 4 is a schematic of a Li-ion battery showing component parts.

FIG. 5 is an electron micrograph of intrapenetrating large and small diameter carbon nanotubes.

FIG. 6A is an electron micrograph of a first example of interpenetrating graphene sheets and carbon nanotubes; FIG. 6B is the cycle performance of a first lithium ion battery comprising mix of first example of graphene sheets and carbon nanotubes.

FIG. 7A is an electron micrograph of a second example of interpenetrating graphene sheets and carbon nanotubes; FIG. 7B is the cycle performance of a second lithium ion battery comprising mix of second example of graphene sheets and carbon nanotubes.

### DETAILED DESCRIPTION OF THE INVENTION

Definitions

The term “three dimensional network of carbonaceous materials” refers herein to fibrous structures of carbon nanotubes and other carbon structures; for example, in some embodiments a three dimensional network comprises carbon nanotubes, CNT; optionally, the CNTs are of a first diameter range, A, and a second diameter range, B; optionally, a three dimensional network of carbonaceous materials comprises carbon nanotubes and graphene, a sheet material; optionally, a three dimensional network of carbonaceous materials comprises carbon nanotubes, graphene and carbon black, a spherical material; optionally, a three dimensional network of carbonaceous materials comprises at least two carbonaceous materials chosen from a group consisting of CNT(A), CNT(B), graphene, carbon black and other forms of carbon. In some embodiments an electrode material may have a plurality of three dimensional networks of carbonaceous materials.

As used herein the term “carbon nanotube” means a hollow carbon structure having a diameter of from about 2 to about 100 nm; for purposes herein we mean multi-walled nanotubes exhibiting little to no chirality. In order to distinguish carbon nanotubes of different diameters, the term “CNT(A)” refers more specifically to nanotubes with diameters between about 4-15 nm; the term “CNT(B) refers more specifically to nanotubes with diameters between about 30-100 nm.

The term “multi-wall carbon nanotube”, MWNT, refers to carbon nanotubes wherein graphene layers form more than one concentric cylinders placed along the fiber axis.

The term “carbon nanotube-based paste” refers to an electro-conductive composite in which an electro-conductive filler is a three dimensional network of carbonaceous materials.

The term “composite” means a material comprising at least one polymer and at least one carbonaceous material.

The term “dispersant” refers to an agent assisting dispersing and stabilizing three dimensional networks of carbonaceous materials in a composite.

The term “carbon nanotube network” refers to a structure, such as a three dimensional network of carbonaceous materials, comprising nanotubes with a “bi-modal” distribution, a mixture of two different uni-modal diameter distributions or distributions having only a narrow range of diameters. Large diameter carbon nanotubes, CNT(B), serve as the backbone of various conductive paths, while small diameter nanotubes, CNT(A), serve to connect individual particles. In some embodiments a range of diameters for small carbon nanotubes, CNT(A), is about 4-15 nm; a range for large diameter nanotubes, CNT(B), is about 30-100 nm.

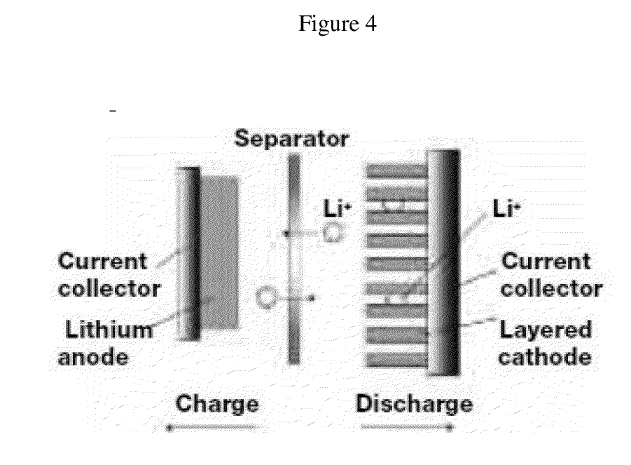

Electrode composition refers to the composition of the electrode active material plus any matrix or composite surrounding the electrode active material. Material of a specific “electrode composition” is coated or bonded to a metallic conductor plate which collects or dispenses electrons, or “current”, when a battery is in an active, discharging, or (re)charging state as shown schematically in FIG. 4.

The term “carbon black” is defined as in Wikipedia, {wikipedia.org/wiki/Carbon_black} [Jul. 1, 2014]. Carbon black (subtypes are acetylene black, channel black, furnace black, lamp black and thermal black) is a material produced by the incomplete combustion of heavy petroleum products such as FCC tar, coal tar, ethylene cracking tar, and a small amount from vegetable oil. Carbon black is a form of paracrystalline carbon that has a high surface-area-to-volume ratio, albeit lower than that of activated carbon. It is dissimilar to soot in its much higher surface-area-to-volume ratio and significantly lower (negligible and non-bioavailable) PAH (polycyclic aromatic hydrocarbon) content.

The term “graphene” is defined as in Wikipedia, {wikipedia.org/wiki/Graphene} [Jul. 1, 2014]. Graphene is a crystalline allotrope of carbon with 2-dimensional properties. In graphene, carbon atoms are densely packed in a regular sp²-bonded atomic-scale chicken wire (hexagonal) pattern. Graphene can be described as a one-atom thick layer of graphite. It is the basic structural element of other allotropes, including graphite, charcoal, carbon nanotubes and fullerenes. It can also be considered as an indefinitely large aromatic molecule, the limiting case of the family of flat polycyclic aromatic hydrocarbons. As used herein the term “graphene” is inclusive of other forms of graphene such as graphene ribbons or nanoribbons, graphene created from cutting open carbon nanotubes, multi-layers of graphene sheets and graphene as produced as a powder or as a dispersion in a polymer matrix, or adhesive, elastomer, oil, aqueous and non-aqueous solutions.

Carbon Nanotubes

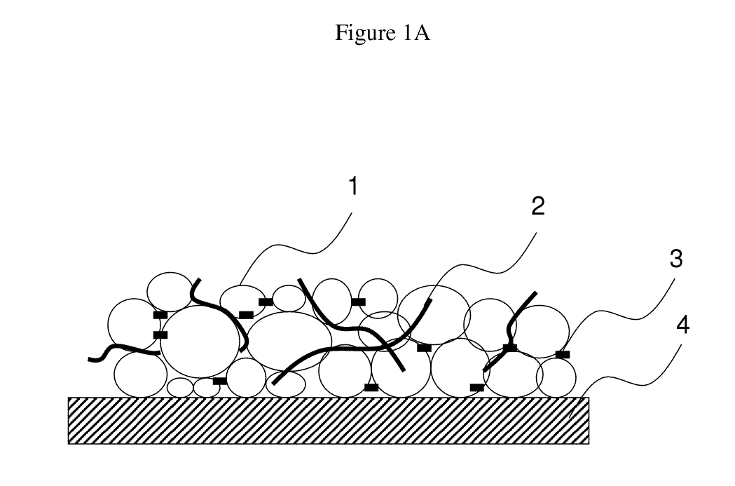

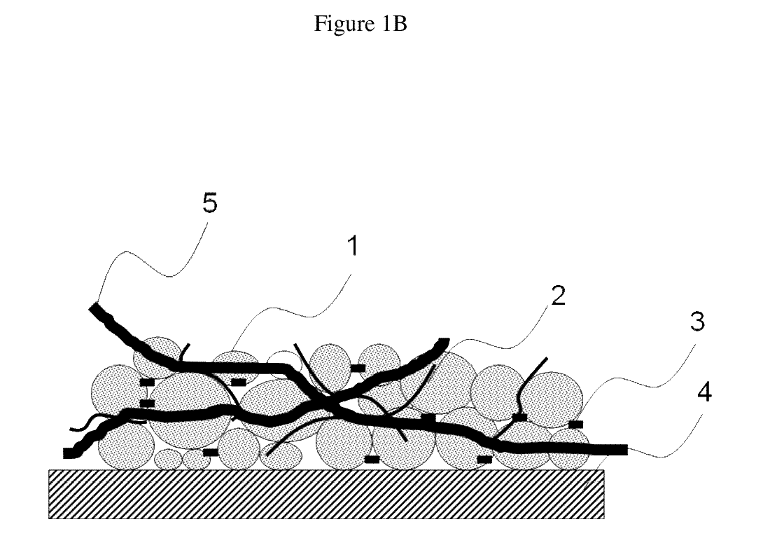

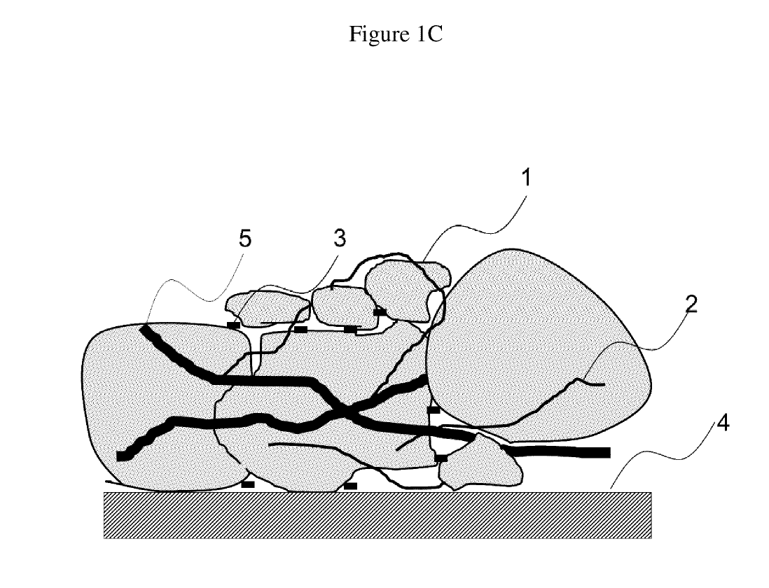

There are various kinds of carbon nanotube structures reported in the art, namely single-walled nanotube, multi-wall nanotube, vapor-phase grown carbon fibers, VGCF, etc. The distinct difference is the diameter, where 0.4-1.2 nm for SWCNT, 2-100 nm for MWCNT, and >100 nm for VGCF. FIG. 1A illustrates a schematic diagram of coating made of active materials 1, carbon nanotubes, CNT(A) 2 and binder 3 on an aluminum film 4 as an electrode of lithium battery. Carbon nanotubes 2, as shown, act as conductive filler to form electrically conductive paths throughout the active material particles, so as to enhance the overall conductivity.

FIG. 1B illustrates both large and small cathode particles 1 in an electrode layer, and mixed, large, CNT(B) 5 and small, CNT(A) 2, diameter carbon nanotubes, and binder 3 forming a carbon nanotube network to accommodate an unconventional packing structure and provide alternative conductive paths.

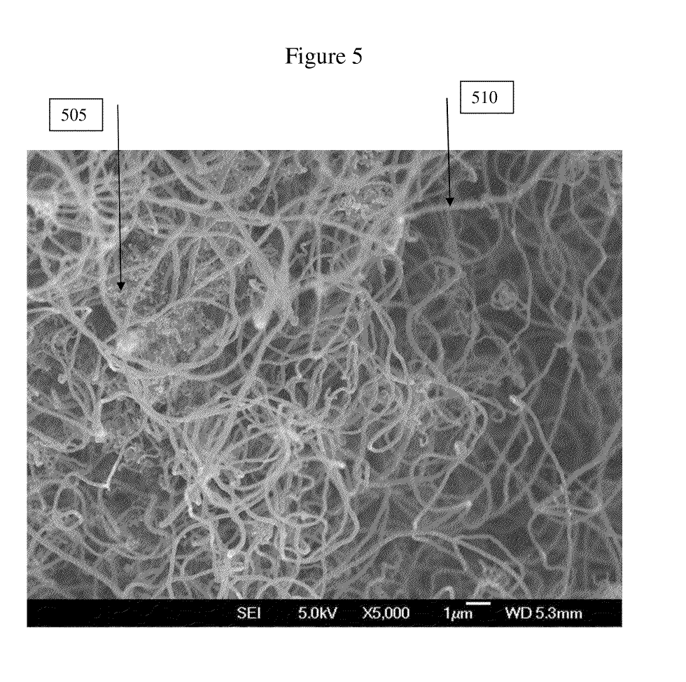

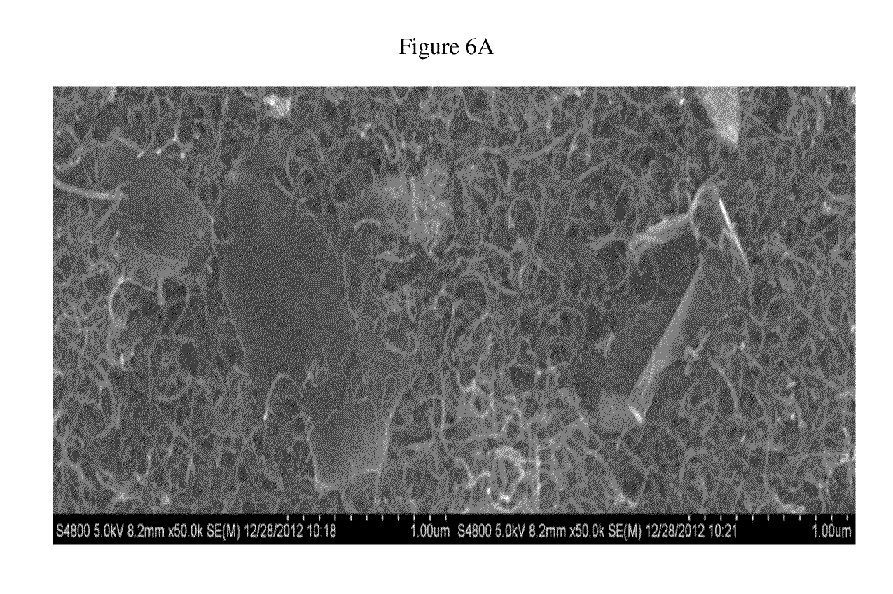

FIG. 1C illustrates schematically both large and small graphite anode carbonaceous particles in an electrode layer, and mixed with large, CNT(B) 5 and small, CNT(A) 2, diameter carbon nanotubes, and binder 3 forming a carbon nanotube network to accommodate an unconventional packing structure and provide alternative conductive paths. FIG. 5 is a SEM at 5,000× showing exemplary intra-penetrating CNT(A) 505 and CNT(B) 510 in a three dimensional network of carbonaceous materials.

Preparation of carbon nanotubes has been documented extensively. Generally, a catalyst is used in a heated reactor under carbonaceous reagents. At elevated temperatures, the catalyst will decompose carbon precursors and the generated carbon species will precipitate in the form of nanotubes on catalyst particles. A continuous mass production of carbon nanotubes networks can be achieved using a fluidized bed, mixed gases of hydrogen, nitrogen and hydrocarbon at a low space velocity as described in U.S. Pat. No. 7,563,427. As-made, carbon nanotubes often form entanglements, also known as three dimensional networks. U.S. Pat. No. 7,563,427; incorporated herein by reference in its entirety, describes such entanglements comprising a plurality of transition metal nanoparticles, a solid support, wherein said plurality of metal nanoparticles and said support are combined to form a plurality of catalyst nano-entanglements; and a plurality of multi-walled carbon nanotubes deposited on a plurality of catalyst nano-entanglements. The entanglements have sizes from about 0.5 to 10,000 micrometers, wherein carbon nanotubes are in the form of multiwall nanotubes having diameters of about 4 to 100 nm. The size of as-made entanglements can be reduced by various means. A representative characteristic of these entanglements is their tap density; the tap density of as-made entanglements can vary from 0.02 to 0.20 g/cm³ depending upon catalyst, growth condition, process design, etc. Rigid entanglements tend to have high tap densities, while fluffy ones and single-walled nanotubes have low tap densities.

Dispersant

Dispersant serves as an aid for dispersing carbon nanotubes in a solvent. It can be a polar polymeric compound, a surfactant, or high viscosity liquid such as mineral oil or wax. Dispersants used in the current invention include poly(vinylpyrrolidone) (PVP), poly(styrene sulfonate) (PSS), poly(phenylacetylene) (PAA), poly(meta-phenylenevinylene) (PmPV), polypyrrole (PPy), poly(p-phenylene benzobisoxazole) (PBO), natural polymers, amphiphilic materials in aqueous solutions, anionic aliphatic surfactant, sodium dodecyl sulfate (SDS), cyclic lipopeptide biosurfactant, surfactin, water-soluble polymers, poly(vinyl alcohol), PVA, sodium dodecyl sulfate, SDS, n-methylpyrrolidone, polyoxyethylene surfactant, poly(vinylidene fluoride), PVdF, carboxyl methyl cellulose (CMC), hydroxyl ethyl cellulose (HEC), polyacrylic acid (PAA), polyvinyl chloride (PVC) and combinations thereof. Polymeric binder choices include the dispersants mentioned as well as polyethylene, polypropylene, polyamide, polyurethane, polyvinyl chloride, polyvinylidene fluoride, thermoplastic polyester resin and combinations thereof.

Polyvinylpyrrolidone, PVP, binds polar molecules extremely well. Depending upon its molecular weight, PVP has different properties when used as a binder or as a dispersing agent such as a thickener. In some embodiments of the instant invention, molecular weights for dispersants and/or binders range between about 9,000 and 1,800,000 Daltons; in some embodiments, between about 50,000 to 1,400,000 Daltons are preferred; in some embodiments between about 55,000 to 80,000 Daltons are preferred.

Liquid Vehicle

A liquid vehicle, aqueous or non-aqueous, may serve as a carrier for carbonaceous materials. Liquid vehicles may be a solvent or a non-solvent, depending upon whether or not a vehicle dissolves solids which are mixed therein. The volatility of a liquid vehicle should not be so high that it vaporizes readily at relatively low temperatures and pressures such as room temperature and pressure, for instance, 25° C. and 1 atm. The volatility, however, should not be so low that a solvent does not vaporize somewhat during paste preparation. As used herein, “drying” or removal of excess liquid vehicle refers to promoting the volatilization of those components which can be substantially removed by baking, or vacuum baking or centrifuging or some other de-liquefying process at temperatures below 100 to 200° C.

In one embodiment, a liquid vehicle is used to dissolve polymeric dispersant(s) and entrain carbonaceous materials in order to render a composition that is easily applied to a substrate. Examples of liquid vehicles include, but are not limited to, water, alcohols, ethers, aromatic hydrocarbons, esters, ketones, n-methyl pyrrolidone and mixtures thereof. In some cases, water is used as a solvent to dissolve polymers and form liquid vehicles. When combined with specific polymers these aqueous systems can replace solvent based inks while maintaining designated thixotropic properties, as disclosed in U.S. Pat. No. 4,427,820, incorporated herein in its entirety by reference.

Nanotube Dispersion

Dispersing carbon nanotubes and carbonaceous materials in a liquid is difficult because of the entanglement of nanotubes in large networks. In some embodiments one means of reducing the size of large networks to acceptable size entanglements is to apply a shear force to an entanglement; a shear force is one technique to aid with dispersion. Means to apply a shear force include, but are not limited to, milling, sand milling, sonication, grinding, cavitation, or others known to one knowledgeable in the art. In one embodiment, carbon nanotubes are first reduced in size by using a jet-miller. The tap density can decrease after dispersion, optionally by milling, to around 0.06 g/cm3 in some embodiments, or 0.04 g/cm³ in some embodiments, or 0.02 g/cm³ in some embodiments. In some embodiments a colloid mill or sand mill or other technique, is then used to provide sufficient shear force to further break up nanotube entanglements, as required by an application.

Preparation of Carbonaceous Material Network

Carbon nanotubes, with diameters of about 50 nm but less than about 100 nm, are known to be straighter than smaller nanotubes; smaller nanotubes are often in the form of entangled networks. In one embodiment a carbon nanotube network with a “bi-modal” nanotube distribution, small diameter nanotubes, CNT(A), are first dispersed into a liquid suspension, such as nMP or water; then large diameter nanotube materials, CNT(B), are added directly to the liquid suspension at desired ratio to small diameter nanotubes followed by vigorous agitation and mixing. The resultant paste then contains mixture of both large and small nanotubes crossing each other and forming the desired network in a new paste. Optionally, additional carbonaceous materials are added into the liquid suspension.

Exemplary lithium ion battery active materials comprise lithium based compounds and or mixtures comprising lithium and one or more elements chosen from a list consisting of oxygen, phosphorous, sulphur, nitrogen, nickel, cobalt, manganese, vanadium, silicon, carbon, aluminum, niobium and zirconium and iron. Typical cathode materials include lithium-metal oxides, such as LiCoO₂, LiMn₂O₄, and Li(NiₓMn_{y}Co_{z})O_{2],} vanadium oxides, olivines, such as LiFePO₄, and rechargeable lithium oxides. Layered oxides containing cobalt and nickel are materials for lithium-ion batteries also.

Exemplary anode materials are lithium, carbon, graphite, lithium-alloying materials, intermetallics, and silicon and silicon based compounds such as silicon dioxide. Carbonaceous anodes comprising silicon and lithium are utilized anodic materials also. Methods of coating battery materials in combination with a carbon nanotube network onto anodic or cathodic backing plates such as aluminum or copper, for example, are disclosed as an alternative embodiment of the instant invention.

### EXAMPLE 1

### Dispersion of Carbon Nanotubes [CNT(A)] in n-methyl Pyrrolidone

30 grams of FloTube™ 9000 carbon nanotubes manufactured by CNano Technology Ltd., pulverized by jet-milling, were placed in 2-liter beaker. The tap density of this material is 0.03 g/mL. In another 500 milliliter beaker, 6 grams of PVP k90 (manufactured by BASF) was dissolved in 100 grams of n-methyl pyrrolidone. Then the PVP solution was transferred to the nanotubes together with 864 grams n-methyl pyrrolidone. After being agitated for an hour, the mixture was transferred to a colloid mill and ground at a speed of 3,000 RPM. A test sample was taken out every 30 min. for evaluation. Viscosity was taken at 25° C. using Brookfield viscometer for each sample and recorded; Hegman scale reading was taken simultaneously. Maximum dispersion was observed after milling for 90 minutes. The fineness of this paste reached better than 10 micrometer after 60 minutes of milling. This sample was named as Sample A.

### EXAMPLE 2

### Electrode Paste Preparation

A PVDF solution was prepared by placing 10 g of PVDF (HSV900) and 100 g n-methyl pyrrolidone in a 500-mL beaker under constant agitation. After all PVDF was dissolved, designated amount of paste (Sample A) from Example 1 and PVDF solution were mixed under strong agitation of 500-1000RPM for 30 minutes. The resultant mixture was named Sample B.

In a separate container, desired weight of active materials such as LiFePO₄ or LiCoO₃ was weighed under nitrogen blanket. Selected amount of Sample B was also added to the active material and the mixture was stirred under high speed, e.g. 5000-7000RPM for 5 hours. The resultant viscosity measured by Brookfield Viscometer should be controlled at 3000-8000 cps for LFP, or 7000-15000 cps for LiCoO₃. The mixing and stirring was carried out in nitrogen environment and temperature not exceeding 40° C. The resultant sample was named Sample C.

### EXAMPLE 3

### Electrode Preparation

Clean aluminum foil was chosen as cathode current collector, and placed on a flat plexiglass. A doctor blade was applied to deposit a thin coating of Sample C of thickness of about 40 micrometer on the surface of aluminum foil. The coated foil was then placed in a dry oven at 100° C. for 2 hours. The cathode plate was then roll-pressed to form a sheet. A round disk of coated foil was punched out of the foil and placed in a coin battery cell. Lithium metal was used as anode, and the coin cell was sealed after assemble the cathode/separator/anode and injecting electrolyte. The made battery was then tested for various charging and discharging performance.

### EXAMPLE 4

### Composition Comparison Between Commercial and Disclosed Electrodes

Various samples containing different cathode materials were prepared using the methods described in Examples 1-3. The electrode composition is listed in Table 1. The cell capacity was measured against different electrode compositions.

TABLE 1
Comparison of electrode composition

| | | Electrode composition (wt %) | | | | | |
|---|---|---|---|---|---|---|---|
| Cathode | | Active | | | Carbon | | Capacity |
| material | Electrode | material | CNT(A) | dispersant | black | PVDF | (mAh/g) |
| LFP | With CNT | 93 | 3 | 0.75 | | 3 | 139.9 |
| | Commercial | 89 | | | 6 | 5 | 133.5 |
| LCO | With CNT | 98 | 0.75 | 0.19 | | 0.75 | 145.6 |
| | Commercial | 97 | | | 2 | 1.5 | 140.9 |
| NCM | With CNT | 97 | 1 | 0.25 | | 1.5 | 139.1 |
| | Commercial | 96 | | | 3 | 1.5 | 135.4 |

### EXAMPLE 5

### Mechanical Comparison of Electrode (Crease Test)

The coated aluminum, Al, foil from Example 3 was further tested for adhesion and anti-crease properties. The foil was folded several times until the coating cracked or peeled off the surface. Table 2 indicates how the coated Al foils can survive multiple folding action. The number represented the number of folding times before the failure occurred.

TABLE 2

| | PVDF | Electrode resistivity | |
|---|---|---|---|
| Conductive additives | (%) | (ohm · cm) | Crease times |
| 2% SP | 1% | 13.0/9.8 | 3 |
| | | | 2 |
| | 2% | 13.9/13.3 | 1 |
| 1% CNT | 0.75% | 11/14.58 | 4 |
| | | | 2 |
| | 1% | 9.6/12.2 | 1 |
| | | | 1 |

### EXAMPLE 6

### Application of Carbon Nanotube Paste on Li-ion Battery Cathode Material

A CNT(A) paste comprising 2% CNT and 0.4% PVP k30 was selected to make a Lithium-ion coin battery. LiFePO4, manufactured by Phostech/Sud Chemie was used as cathode material and Lithium foil was used as anode. The cathode materials contains LiFePO4, CNT, PVP, and PVDF was prepared by mixing appropriate amount of LiFePO4, CNT paste and PVDF together with n-methyl pyrrolidone in a warren blender. Coating of such paste was made on an Al foil using a doctor blade followed by drying and compression. As a comparison, an electrode was prepared using Super-P carbon black (CB) to replace CNT in a similar fashion as described before. The composition and bulk resistivity of the two battery electrodes were summarized in the following table. Clearly, CNT-added electrode has much lower bulk resistivity than carbon black modified sample with the same concentration.

TABLE 3
Battery composition of CNT and carbon black modified lithium ion battery

| Content | CNT(A) | CB |
|---|---|---|
| LiFePO4 | 86.8% | 88% |
| Carbon additives | 2% | 2% |
| PVP | 0.4% | — |
| PVDF | 5% | 5% |
| Bulk resistivity (ohm-cm) | 3.1 | 31 |

### EXAMPLE 7

### Life Cycle Evaluation

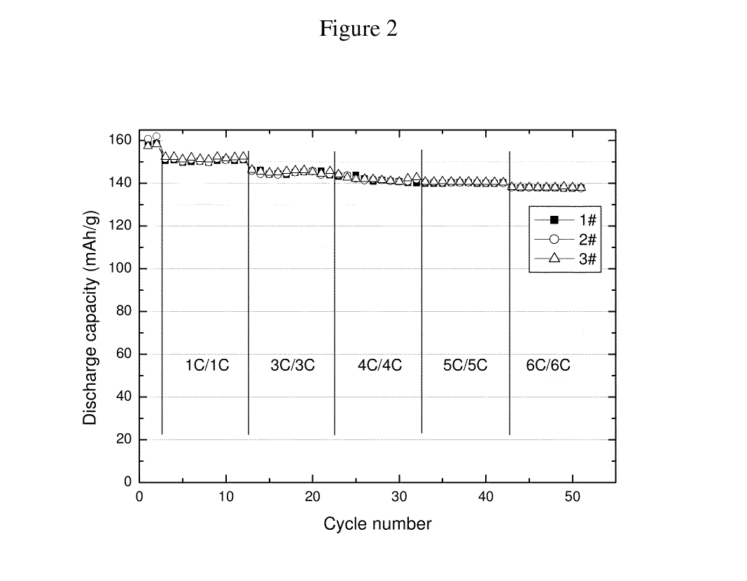

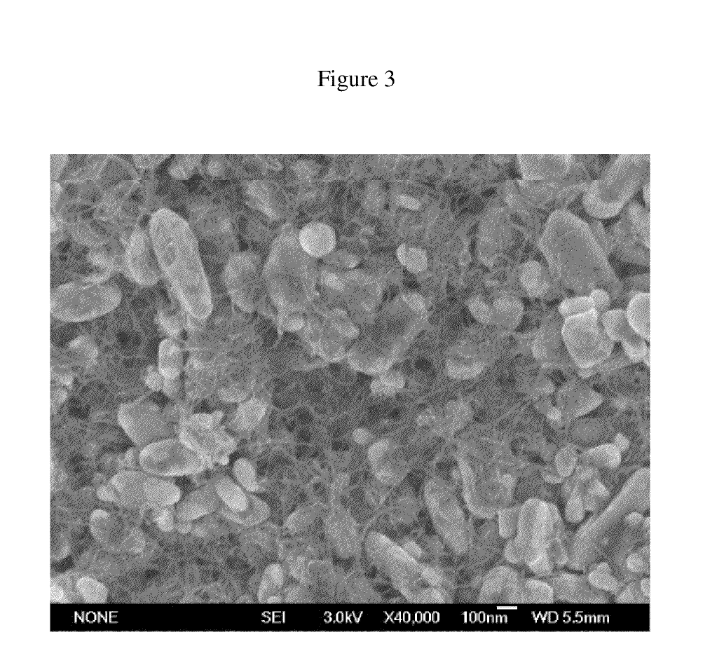

A battery assembled using the method described in Example 3 was tested for cycle life performance under different charging rate. FIG. 2 illustrates a carbon nanotube [CNT(A)] embedded electrode exhibiting excellent cycle life performance at various charge rates. The inventors have discovered, however, that the amount of polymeric binder needed in electro-conductive pastes can be eliminated or significantly reduced when using multiwall carbon nanotubes of the present invention as an electro-conductive filler and various polymers, for example, polyvinylpyrrolidone (PVP), as dispersant. As a result, the inventors have discovered that conductivity of electro-conductive pastes can be significantly improved.

In some embodiments an electrode composition comprises carbon nanotube networks; a dispersant; and a liquid vehicle; wherein the carbon nanotube networks are dispersed as defined by a Hegman scale reading of 7 or more; optionally, the carbon nanotubes are multiwall carbon nanotubes; optionally carbon nanotubes are in a spherical networks; optionally, an electrode composition comprises a dispersant selected from a group consisting of poly(vinylpyrrolidone) (PVP), poly(styrene sulfonate) (PSS), poly(phenylacetylene) (PAA), poly(meta-phenylenevinylene) (PmPV), polypyrrole (PPy), poly(p-phenylene benzobisoxazole) (PBO), natural polymers, amphiphilic materials in aqueous solutions, anionic aliphatic surfactant, sodium dodecyl sulfate (SDS), cyclic lipopeptide biosurfactant, surfactin, water-soluble polymers, carboxyl methyl cellulose, hydroxyl ethyl cellulose, poly(vinyl alcohol), PVA, sodium dodecyl sulfate, SDS, polyoxyethylene surfactant, poly(vinylidene fluoride), PVdF, carboxyl methyl cellulose (CMC), hydroxyl ethyl cellulose (HEC), polyacrylic acid (PAA), polyvinyl chloride (PVC) and combinations thereof; optionally the dispersant is poly(vinylpyrrolidone); optionally, a comprises a liquid vehicle selected from a group consisting of water, alcohols, ethers, aromatic hydrocarbons, esters, ketones, n-methyl pyrrolidone and mixtures thereof; optionally, an electrode composition has a solid state bulk electrical resistivity less than 10⁻¹ Ω-cm and a viscosity greater than 5,000 cps; optionally, an electrode composition comprises carbon nanotube networks having a maximum dimension from about 0.5 to about 1000 micrometers; optionally, an electrode composition has carbon nanotubes with a diameter from about 4 to about 100 nm; optionally, an electrode composition comprises carbon nanotube networks made in a fluidized bed reactor; optionally, an electrode composition comprises carbon nanotube networks have been reduced in size by one or more processes chosen from a group consisting of jet mill, ultra-sonicator, ultrasonics, colloid-mill, ball-mill, bead-mill, sand-mill, dry milling and roll-mill; optionally, an electrode composition has a tap density of the carbon nanotube networks greater than about 0.02 g/cm³; optionally, an electrode composition comprises carbon nanotube networks present in the range of about 1 to 15% by weight of paste; optionally, an electrode composition has a dispersant is present in the range of 0.2 to about 5% by weight of the paste; optionally, an electrode composition has a ratio of the dispersant weight to carbon nanotube networks weight less than 1.

In some embodiments a method for making an electrode composition comprises the steps: selecting carbonaceous material networks; adding the carbonaceous material networks to a liquid vehicle to form a suspension; dispersing the carbonaceous materials in the suspension; reducing the size of the networks to a Hegman scale of 7 or less; and removing a portion of the liquid vehicle from the suspension to form a concentrated electrode composition such that the electrode composition has carbonaceous materials present in the range of about 1 to 10% by weight, a bulk electrical resistivity of about 10⁻¹ Ω-cm or less and a viscosity greater than 5,000 cps; optionally, a method further comprises the step of mixing a dispersant with the liquid vehicle before adding the carbonaceous material networks; optionally, a method wherein the dispersing step is performed by a means for dispersing chosen from a group consisting of jet mill, ultra-sonicator, ultrasonics, colloid-mill, ball-mill, bead-mill, sand-mill, dry milling and roll-mill.

In some embodiments an electrode composition consists of multi-walled carbon nanotubes of diameter greater than 4 nm; a dispersant chosen from a group consisting of poly(vinylpyrrolidone) (PVP), poly(styrene sulfonate) (PSS), poly(phenylacetylene) (PAA), poly(meta-phenylenevinylene) (PmPV), polypyrrole (PPy), poly(p-phenylene benzobisoxazole) (PBO), natural polymers, amphiphilic materials in aqueous solutions, anionic aliphatic surfactant, sodium dodecyl sulfate (SDS), cyclic lipopeptide biosurfactant, surfactin, water-soluble polymers, carboxyl methyl cellulose, hydroxyl ethyl cellulose, poly(vinyl alcohol), PVA, sodium dodecyl sulfate, SDS, polyoxyethylene surfactant, poly(vinylidene fluoride), PVdF, carboxyl methyl cellulose (CMC), hydroxyl ethyl cellulose (HEC), polyacrylic acid (PAA), polyvinyl chloride (PVC) and combinations thereof; and a liquid vehicle chosen from a group consisting of water, alcohols, ethers, aromatic hydrocarbons, esters, ketones, n-methyl pyrrolidone and mixtures thereof such that the electrode composition has carbonaceous material networks present in the range of about 1 to 10% by weight, a bulk electrical resistivity of about 10⁻¹ Ω-cm or less and a viscosity greater than 5,000 cps; optionally, an electrode composition further consists of lithium ion battery electrode materials chosen from a group consisting of lithium, oxygen, phosphorous, nitrogen, nickel, cobalt, manganese, vanadium, silicon, carbon, aluminum, niobium and zirconium and iron wherein the electrode composition is present in a range from about 30% to about 50% by weight and the viscosity is greater than about 5,000 cps; optionally, an electrode composition further consists of a polymeric binder; optionally, an electrode composition is contacting a metallic surface to form an electrode for a lithium ion battery and the liquid vehicle is removed.

In some embodiments a method of preparing an battery electrode coating using a paste composition as disclosed herein comprises the steps: mixing the paste composition with lithium ion oxide compound materials; coating the paste onto a metallic film to form an electrode for a lithium ion battery and removing excess or at least a portion of the liquid from the coating; optionally, a method further comprises the step of mixing a polymeric binder with a liquid vehicle before mixing the paste composition with lithium ion battery materials; optionally, a method uses a polymeric binder chosen from a group consisting of polyethylene, polypropylene, polyamide, polyurethane, polyvinyl chloride, polyvinylidene fluoride, thermoplastic polyester resins, and mixtures thereof and is less than about 5% by weight of the paste composition; optionally, a method utilizes spherical carbon nanotube entanglements fabricated in a fluidized bed reactor as described in Assignee's inventions U.S. Pat. No. 7,563,427, and U.S. Applications 2009/0208708, 2009/0286675, and U.S. Ser. No. 12/516,166. Optionally, a paste composition as disclosed herein utilizes carbonaceous material networks at some portions fabricated in a fluidized bed reactor as described in Assignee's inventions U.S. Pat. No. 7,563,427, and U.S. Applications 2009/0208708, 2009/0286675, and U.S. Ser. No. 12/516,166.

In some embodiments an electrode material composition, or electrode material, for coating to a metallic current collector or metal conductor for a lithium battery comprises a bi-modal distribution of multi-walled carbon nanotubes in networks; electrode active materials chosen from a group consisting of lithium, oxygen, phosphorous, sulphur, nitrogen, nickel, cobalt, manganese, vanadium, silicon, carbon, graphite, aluminum, niobium, titanium and zirconium and iron; a dispersant chosen from a group consisting of poly(vinylpyrrolidone) (PVP), poly(styrene sulfonate) (PSS), poly(phenylacetylene) (PAA), poly(meta-phenylenevinylene) (PmPV), polypyrrole (PPy), poly(p-phenylene benzobisoxazole) (PBO), natural polymers, amphiphilic materials in aqueous solutions, anionic aliphatic surfactant, sodium dodecyl sulfate (SDS), cyclic lipopeptide biosurfactant, surfactin, water-soluble polymers, carboxyl methyl cellulose, hydroxyl ethyl cellulose, poly(vinyl alcohol), PVA, sodium dodecyl sulfate, SDS, n-methylpyrrolidone, polyoxyethylene surfactant, poly(vinylidene fluoride), PVdF, carboxyl methyl cellulose (CMC), hydroxyl ethyl cellulose (HEC), polyacrylic acid (PAA), polyvinyl chloride (PVC) and combinations thereof; and a polymeric binder chosen from a group consisting of polyethylene, polypropylene, polyamide, polyurethane, polyvinyl chloride, polyvinylidene fluoride, thermoplastic polyester resins and mixtures thereof and is less than about 0.5% to 5% by weight of the electrode material composition wherein the electrode active material is 30-50% by weight, the carbonaceous material networks are present in a range from about 1 to about 10% by weight, and the dispersant is less than 0.1 to 2% by weight before coating to a metallic current collector; after coating and drying the electrode active material is more than 80% by weight and in some embodiments more than 90% by weight; optionally, an electrode material composition comprises carbon nanotube networks made in a fluidized bed reactor; optionally, an electrode material composition comprises carbon nanotube networks with a maximum dimension from about 0.5 to about 1,000 microns; optionally, an electrode material composition comprises carbon nanotubes with a diameter from about 4 to about 100 nm; optionally, an electrode material comprises carbon nanotubes wherein the tap density of the carbon nanotube entanglements is greater than about 0.02 g/cm³; optionally, an electrode material comprises carbonaceous material networks wherein the bulk resistivity of the material is less than 10 ohm-cm; optionally less than less than 1 ohm-cm; optionally less than 0.1 ohm-cm; optionally less than 0.05 ohm-cm.

In some embodiments a method of preparing an electrode material using the electrode material composition herein disclosed comprises the steps: forming a paste composition comprising carbonaceous material networks, dispersant and polymeric binders; mixing the paste composition with a lithium ion battery active material composition wherein the paste composition is in a range from about 30% to about 50% by weight of the mixed composition; coating the mixed paste composition and active material composition onto a metal conductor or electrode; and removing excess volatile components to form an electrode for a battery, optionally, lithium ion, such that after removal of the excess volatile components the active material composition is more than about 80% by weight of the coated paste and battery material composition; optionally, a method wherein the active material composition is more than about 90% by weight of the coated paste and battery material composition after removal of the excess volatile components; optionally, a method further comprising the step of mixing a polymeric binder with a liquid vehicle before mixing the paste composition with lithium ion battery materials; optionally, a method wherein the polymeric binder is chosen from a group consisting of polyethylene, polypropylene, polyamide, polyurethane, polyvinyl chloride, polyvinylidene fluoride, thermoplastic polyester resins, and mixtures thereof and is less than about 5% by weight of the paste composition; optionally, a method wherein the lithium ion battery electrode active materials are chosen from a group consisting of lithium, oxygen, phosphorous, sulphur, nitrogen, nickel, cobalt, manganese, vanadium, silicon, carbon, graphite, aluminum, niobium, titanium, and zirconium and iron; optionally, a method wherein the carbonaceous material networks, dispersant and polymeric binders are formed into a dry pellet prior to mixing with the lithium ion battery active material composition. In some embodiments a dry pellet comprising carbonaceous material networks, dispersant and polymeric binders is formed to facilitate shipment to a different location where mixing with a liquid vehicle or additional dispersant may be done prior to coating an electrode composition onto a metallic electrical conductor or base electrode prior to redrying.

### EXAMPLE 8

### Preparation of Large Diameter Carbon Nanotubes [CNT(B)] on a Ni/SiO₂ Catalyst

The preparation of large diameter carbon nanotubes was carried out by catalytic decomposition of hydrocarbons such as propylene. A catalyst was prepared using silica gel with average particle size of 5 μm. Nickel nitrate was impregnated on these silica particles in a ratio of about 1 part nickel to 1.5 parts by weight of silica. The resultant particle was then calcined in air at 400° C. for 2 hours. A two (2) inch quartz reactor tube was heated to about 600° C. while it was being purged with nitrogen. A mixed flow of hydrogen, at 1 liter/min and nitrogen at 1 liter/min was fed to the hot tube for five minutes whereupon catalyst was introduced into the reactor tube. The reduction was allowed to carry for about 10 minutes before a mixture of propylene/nitrogen (1:1) mixture was passed through the reactor at 2 liter/min. The reaction was continued for 0.5 hours after which the reactor was allowed to cool to room temperature under argon. Harvesting of the nanotubes so produced showed a yield of greater than 15 times the weight of the catalyst. Final product was retrieved as black fluffy powder. Scan electron micrographs revealed the diameter of carbon nanotubes of 50-70 nm.

### EXAMPLE 9

### Preparation of Large Diameter Nanotubes [CNT(B)] on a Cu—Ni—Al Catalyst

The catalyst was prepared via co-precipitation of Cu nitrate, Ni nitrate, and Al nitrate. In a round bottom flask, the three nitrates were weighed, and dissolved using deionized water at the molar ratio of Cu:Ni:Al of 3:7:1. Then a solution containing 20% ammonium bicarbonate was slowly added to the flask under continuous agitation. After the pH reached at 9, at which point the precipitation ceased, the resultant suspension was allowed to digest under constant stirring for 1 hour. The precipitates were then washed with deionized water followed by filtration, drying and calcination. The resultant catalyst contained 50 wt % Ni, 24 wt % Cu and 3.5 wt % Al. Nanotubes were prepared following the procedure described in Example 8 at 680° C. using 1 gram of catalyst. A total of 30 g of nanotubes was isolated for a weight yield of 29 times the catalyst. Scan electron micrograph revealed the carbon nanotubes made from this process have average diameters of 80 nm.

### EXAMPLE 10

### Mixing of Large and Small Nanotubes and Electrode Preparation

CNT(B) were blended with conductive paste containing 5% small nanotubes CNT(A) made from Example 1 at a mass ratio of 3:140 in a Ross mixer for 5 hours; the “140” is the mass of the conductive paste comprising 5% CNT(A), resulting in a mixture of two distinct carbon nanotubes, (A) and (B), at a mass ratio of I:II is 7:3; the proportion of large diameter nanotubes to total nanotube content is 30% by weight. An electrode coating composition was then prepared using paste containing mixed large and small nanotubes with graphite particles, with average diameter of 20 micrometers, together with other necessary binders, such as PVDF. The coating formula was then applied to a Mylar sheet for resistivity measurement, and copper foil to be used as a battery anode. The coated sheet was further subjected to compression under constant pressure, e.g. 10 kg/cm².

The bulk resistivity was measured using a 4-point probe and the results are listed in Table 4.

TABLE 4

| Bulk resistivity (Ohm-cm) | CNT(A)/Graphite | CNT(I&II)/Graphite |
|---|---|---|
| Without compression | 0.33 | 0.38 |
| After compression | 0.012 | 0.0086 |

From the data, it is clear that mixed large and small nanotubes provide better electrical contact within a graphite particle matrix and resulted in much decreased bulk resistivity, versus using single sized, small carbon nanotubes, the conductivity is good but not optimized for a spacious pore volume present with large graphite particles.

### EXAMPLE 11

### Electrode Preparation with Graphene and Carbon Nanotubes

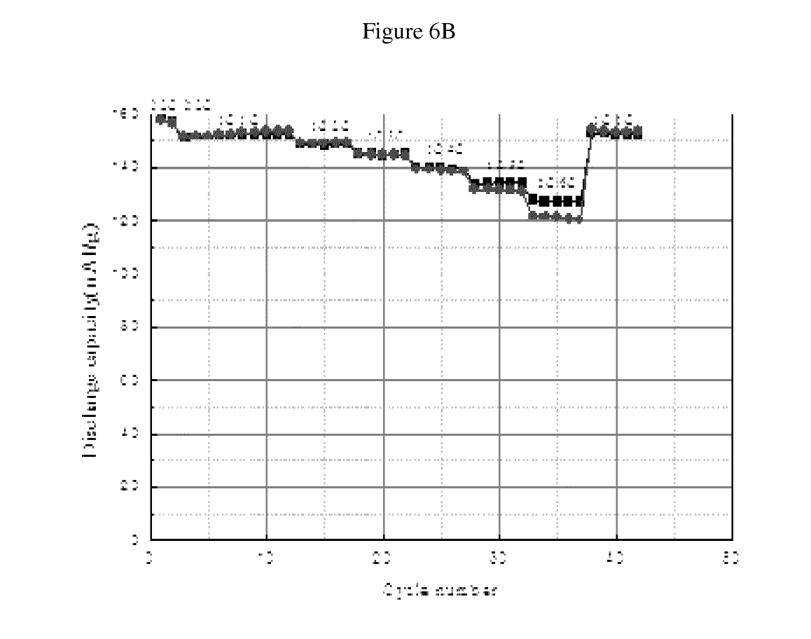

5 grams of polyvinyl pyrrolidone (PVP) powder was added into 470 grams of N-methyl pyrrolidone (NMP) solvent and agitated till completely dissolved. Added the PVP/NMP solution, together with 20 grams of the pulverized FloTube™ 9000 multi-walled carbon nanotubes and 5 grams of one type of graphene powder (specific surface area 150 m²/g) to a colloid mill and ground at a speed of 3,000 RPM. A test sample was taken out every 30 min. for evaluation. Viscosity was taken at 25° C. using Brookfield viscometer for each sample and recorded; Hegman scale reading was taken simultaneously. Maximum dispersion was observed after milling for 180 minutes. The fineness of this paste reached better than 10 micrometer after 60 minutes of milling. This paste was named as Sample A1. An SEM image is shown in FIG. 6A. There appears to be some curled graphene sheet due to very thin sheet. A type of a somewhat thicker graphene sheet is used in Example 12 below.

The above paste sample A1, comprising 4% CNT and 1% graphene, was used to make a lithium-ion coin battery. LiFePO4, manufactured by Phostech/Sud Chemie was used as cathode material and lithium foil was used as anode. The cathode materials contains LiFePO4, CNT, PVP, and PVDF was prepared by mixing appropriate amount of LiFePO4, CNT paste and PVDF together with n-methyl pyrrolidone in a high speed blender at a speed of 3,000 RPM. Coating of such paste was made on an Al foil using a doctor blade followed by drying and compression. A SEM image is shown in FIG. 6A. A battery assembled using the method described in Example 3 was tested for cycle life performance under different discharging rate as shown in FIG. 6B. It is illustrated that an electrode embedded with a mixture of graphene sheets and carbon nanotubes has excellent cycle life performance at various charge rates.

### EXAMPLE 12

### Mixing of Graphene and Carbon Nanotubes and Electrode Preparation

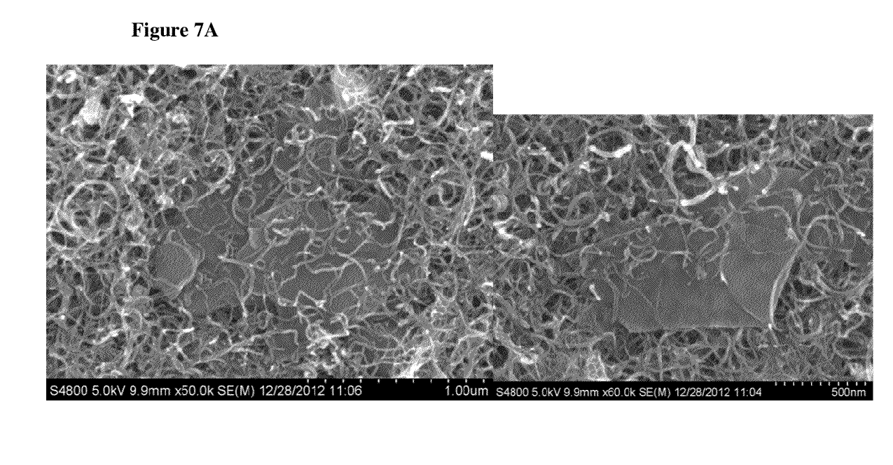

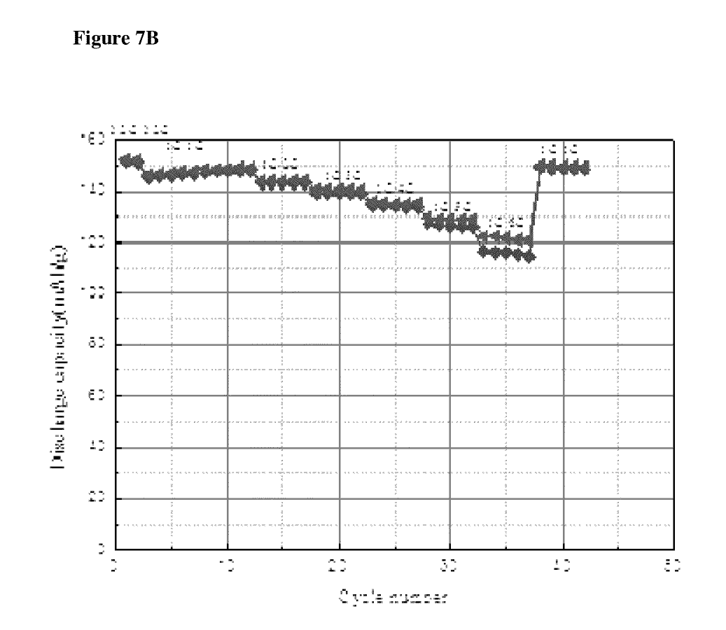

Following the same procedure as Example 11, however using a second type of graphene (specific surface area 50 m²/g) to make a second paste, Sample A2. A SEM image is shown in FIG. 7A. The above paste sample A2 was used to make a lithium-ion coin battery following the same procedure as in Example 11 and was tested for cycle life performance under different discharging rate as shown in FIG. 7B. It is again illustrated that electrode embedded with the mix of graphene sheets and carbon nanotube have excellent cycle life performance at various charge rate

In some embodiments it is advantageous to have an electrode composition comprising a portion of large diameter carbon nanotubes and a portion of small diameter carbon nanotubes. For some embodiments of the disclosed invention “large diameter” CNT, CNT(B), is defined as those nanotubes whose diameter is between about 40 nm to about 100 nm; “small diameter” CNT, CNT(A), is defined as those nanotubes whose diameter is between about 4 nm and 15 nm. Large diameter nanotubes, defined as 30-100 nm, are typically much longer, at least 1-10 micrometers or longer than small diameter nanotubes, forming major conductive pathways. Small diameter CNT's serve as “local pathways” or networks. In some embodiments the portion, by weight, of small diameter nanotubes, A, ranges from about 50% to about 95%. Example 10 above is a ratio of “A”/[“A”+“B”] equals about 70%.

In some embodiments an electrode material composition for a coating applied to a conductive electrode, one of a cathode or anode, for a battery comprises multi-walled carbon nanotubes in an entanglement comprising a first portion of large diameter carbon nanotubes, CNT(B), and a second portion of small diameter carbon nanotubes, CNT(A), such that the weight ratio of the second portion to the combined weight of the first portion and the second portion is between about 0.05 to about 0.50; electrode active materials; dispersant; and polymeric binder such that the polymeric binder is less than about 0.5% to about 5% by weight of the electrode material composition wherein the electrode active material is in a range of about 30-60% by weight, the total carbon nanotubes are in a range from about 0.2 to about 5% by weight and the dispersant is in a range from about 0.1 to 2% by weight before applying the coating to the electrode; optionally the carbon nanotube entanglements are made in a fluidized bed reactor; optionally the carbon nanotube entanglements have a maximum dimension from about 0.5 to about 1,000 microns; optionally the large diameter carbon nanotubes have a diameter in a range from about 40 nm to about 100 nm and the small diameter carbon nanotubes have a diameter in a range from about 5 nm to about 20 nm; optionally the tap density of the carbon nanotube entanglements is greater than about 0.02 g/cm³; optionally the bulk resistivity of the electrode coating is less than 10 Ohm-cm for cathode and 1 Ohm-cm for anode.

In some embodiments a method of preparing an electrode coating material comprises the steps: forming a paste composition comprising carbon nanotube entanglements, dispersant and polymeric binders; mixing the paste composition with a battery active material composition wherein the paste composition is in a range from about 1% to about 25% by weight of the mixed composition; coating the mixed paste composition and active material composition onto an electrical conductor; and removing excess volatile components to form an electrode for a battery such that after removal of the excess volatile components the active material composition is more than about 80% by weight of the coated paste and battery material composition and the bulk resistivity of the coating is less than about 10 Ohm-cm for a cathode or 1 Ohm.cm for an anode; optionally the active material composition is more than about 90% by weight of the coated paste and battery material composition after removal of the excess volatile components; optionally the method further comprises the step of mixing a polymeric binder with a liquid vehicle before mixing the paste composition with lithium ion battery materials; optionally the polymeric binder is chosen from a group consisting of polyethylene, polypropylene, polyamide, polyurethane, polyvinyl chloride, polyvinylidene fluoride, thermoplastic polyester resins, and mixtures thereof and is less than about 5% by weight of the paste composition; optionally the battery electrode active materials are chosen from a group consisting of lithium, oxygen, phosphorous, sulphur, nitrogen, nickel, cobalt, manganese, vanadium, silicon, carbon, graphite, aluminum, niobium, titanium, and zirconium and iron; optionally the multi-walled carbon nanotube entanglements, dispersant and polymeric binders are formed into a dry pellet prior to mixing with the battery active material composition.

In some embodiments a material composition for coating to a conductive collector or for a conductive layer on a battery electrode comprises conductive additives comprising three dimensional networks of at least two carbonaceous materials chosen from a group consisting of carbon nanotubes of first diameter, CNT(A), carbon nanotubes of second diameter CNT(B), graphene and carbon black; electrode material; dispersant; and polymeric binder wherein the polymeric binder is between about 0.005 to about 0.10 by weight fraction of the material composition wherein the electrode material is about 0.30 to 0.90 by weight fraction; the carbonaceous materials are in a range from about 0.01 to about 0.20 by weight fraction; optionally, the carbonaceous materials are in a range from about 0.01 to about 0.10 by weight fraction; and the dispersant is less than about 0.001 to about 0.10 by weight fraction before coating to a collector; optionally, the carbonaceous materials are in a range from about 0.05 to about 0.20 by weight fraction optionally, the bulk resistivity of the material composition is between about 0.01 and 10 ohm-cm; optionally the dispersant is chosen from a group consisting of polyvinyl pyrrolidone, and Hypermer KD-1 such that the dispersant is stable at voltages about 4.4 volts; optionally the polymeric binder is PVDF; optionally the electrode material is chosen from a group consisting of Li cobalt oxides, Li iron phosphate, Li nickel oxide, Li manganese oxides, Li nickel-cobalt-manganese complex oxides, Li—S, Li nickel-cobalt-aluminum oxides, and combinations thereof; optionally the three dimensional networks of carbonaceous materials comprise a first portion of small diameter carbon nanotubes, CNT(A), and a second portion of large diameter carbon nanotubes, CNT(B), such that the weight ratio of the first portion, CNT(A), to the combined weight of the first portion and the second portion is between about 0.50 to about 0.95; optionally the three dimensional networks of carbonaceous materials further contain graphene such that the weight ratio of graphene to CNT(A+B) is 0.05 to 0.5 by weight; optionally the three dimensional networks of carbonaceous materials further contain graphene and carbon black, wherein the carbonaceous content of the conductive additive contains about 70%±10% CNT(A+B), about 20%±5% of graphene, and about 10%±5% of carbon black by weight.

In some embodiments a method of preparing a material composition for coating to a conductive collector or as a conductive layer on a battery electrode comprises the steps; forming a first composition comprising three dimensional networks of carbonaceous materials, dispersant, and polymeric binders; dispersing the three dimensional networks throughout the first composition into a liquid vehicle; mixing the first composition, and liquid vehicle with a battery material composition to make the material composition wherein the first composition is in a range from about 0.01 to about 0.50 by weight fraction of the material composition of the material composition; coating the mixed material composition onto a conductive collector; and removing excess components to form an electrode for a battery such that after removal of the excess components the battery material composition is more than about 80% by weight of the mixed composition; optionally the polymeric binder is chosen from a group consisting of polyethylene, polypropylene, polyamide, polyurethane, polyvinyl chloride, polyvinylidene fluoride, thermoplastic polyester resins, and mixtures thereof and is less than about 5% by weight of the total material composition; optionally the battery material compositions are chosen from a group consisting of lithium, oxygen, phosphorous, sulphur, nitrogen, nickel, cobalt, manganese, vanadium, silicon, carbon, graphite, aluminum, niobium, titanium, zirconium and iron; optionally the first composition is formed into a dry pellet prior to mixing with the battery material composition; optionally the three dimensional networks of carbonaceous materials are chosen from a group consisting of carbon nanotubes of at least two different diameters such that the weight fraction of the smaller diameter CNT(A) to the combined weight of both diameter CNTs is between about 0.50 to about 0.95; optionally the three dimensional networks of carbonaceous materials further contain graphene such that the weight ratio of graphene to the combined weight of both diameter CNTs is between about 0.05 to 0.5 by weight fraction; optionally the three dimensional networks of carbonaceous materials further contain carbon black, such that the combined weight is about 70%±10% of both diameter CNTs, about 20%±5% of graphene, and about 10%±5% of carbon black; optionally the dispersant is chosen from a group consisting of poly(vinylpyrrolidone) (PVP), poly(styrene sulfonate) (PSS), poly(phenylacetylene) (PAA), poly(meta-phenylenevinylene) (PmPV), polypyrrole (PPy), poly(p-phenylene benzobisoxazole) (PBO), natural polymers, amphiphilic materials in aqueous solutions, anionic aliphatic surfactant, sodium dodecyl sulfate (SDS), cyclic lipopeptide biosurfactant, surfactin, water-soluble polymers, carboxyl methyl cellulose, hydroxyl ethyl cellulose, poly(vinyl alcohol), PVA, sodium dodecyl sulfate, SDS, n-methylpyrrolidone, polyoxyethylene surfactant, poly(vinylidene fluoride), PVDF, carboxyl methyl cellulose (CMC), hydroxyl ethyl cellulose (HEC), polyacrylic acid (PAA), polyvinyl chloride (PVC) and combinations thereof such that the dispersant is stable at voltages about 4.4 volts.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements. All publications, patents, and patent applications cited herein are hereby incorporated by reference in their entirety for all purposes.

What we claim is:

1. A material composition for a conductive layer on a battery electrode comprising;
conductive additives comprising three dimensional networks of at least two carbonaceous materials chosen from a group consisting of carbon nanotubes of first diameter, CNT(A), carbon nanotubes of second diameter CNT(B), graphene and carbon black;
electrode material;
dispersant; and
polymeric binder; wherein the weight fractions of the components of the material composition are between about 0.01 to about 0.05 of the polymeric binder; the electrode material is between about 0.30 to 0.90; the carbonaceous materials are in a range from about 0.005 to about 0.10 by weight fraction, and the dispersant is between about 0.001 to about 0.005.

2. The material composition of claim 1 wherein the bulk resistivity of the material composition is between about 0.01 and 10 ohm-cm.

3. The material composition of claim 1 wherein the dispersant is chosen from a group consisting of polyvinyl pyrrolidone, and Hypermer KD-1 such that the dispersant is stable at voltages about 4.4 volts.

4. The material composition of claim 1 wherein the polymeric binder is PVDF.

5. The material composition of claim 1 wherein the electrode material is chosen from a group consisting of Li cobalt oxides, Li iron phosphate, Li nickel oxide, Li manganese oxides, Li nickel-cobalt-manganese complex oxides, Li—S, Li nickel-cobalt-aluminum oxides, and combinations thereof.

6. The material composition of claim 1 wherein the three dimensional networks of carbonaceous materials comprise a first portion of small diameter carbon nanotubes, CNT(A), and a second portion of large diameter carbon nanotubes, CNT(B), such that the weight ratio of the first portion, CNT(A), to the combined weight of the first portion and the second portion is between about 0.50 to about 0.95.

7. The material composition of claim 7 wherein the three dimensional networks of carbonaceous materials further contain graphene such that the weight ratio of graphene to CNT(A+B) is between about 0.05 to about 0.5 by weight.

8. The material composition of claim 7 wherein the three dimensional networks of carbonaceous materials further contain graphene and carbon black, wherein the carbonaceous content of the conductive additive contains about 70%±10% CNT(A+B), about 20%±5% of graphene, and about 10%±5% of carbon black by weight.

9. A method of preparing a material composition for a conductive layer on a battery electrode comprising the steps:
forming a first composition comprising three dimensional networks of carbonaceous materials, dispersant, and polymeric binders;
dispersing the three dimensional networks throughout the first composition into a liquid vehicle;
mixing the first composition and liquid vehicle with a battery material composition to make the material composition wherein the first composition is in a range from about 0.01 to about 0.50 by weight fraction of the material composition;
coating the material composition onto the battery electrode; and
removing excess components to form an electrode for a battery such that after removal of the excess components the battery material composition is more than about 0.80 by weight fraction of the mixed composition.

10. The method of claim 9 wherein the polymeric binder is chosen from a group consisting of polyethylene, polypropylene, polyamide, polyurethane, polyvinyl chloride, polyvinylidene fluoride, thermoplastic polyester resins, and mixtures thereof and is less than about 10% by weight of the total material composition.

11. The method of claim 9 wherein the battery material composition are chosen from a group consisting of lithium, oxygen, phosphorous, sulphur, nitrogen, nickel, cobalt, manganese, vanadium, silicon, carbon, graphite, aluminum, niobium, titanium, zirconium and iron.

12. The method of claim 9 wherein the three dimensional networks of carbonaceous materials are chosen from a group consisting of carbon nanotubes of at least two different diameters such that the weight fraction of the smaller diameter CNT(A) to the combined weight of both diameter CNTs is between about 0.50 to about 0.95.

13. The method of claim 12 wherein the three dimensional networks of carbonaceous materials further contain graphene such that the weight ratio of graphene to the combined weight of both diameter CNTs is between about 0.05 to 0.5 by weight.

14. The material composition of claim 13 wherein the three dimensional networks of carbonaceous materials further contain carbon black, such that the combined weight is about 70%±10% of both diameter CNTs, about 20%±5% of graphene, and about 10%±5% of carbon black.

15. The method of claim 9 wherein the dispersant is chosen from a group consisting of poly(vinylpyrrolidone) (PVP), poly(styrene sulfonate) (PSS), poly(phenylacetylene) (PAA), poly(meta-phenylenevinylene) (PmPV), polypyrrole (PPy), poly(p-phenylene benzobisoxazole) (PBO), natural polymers, amphiphilic materials in aqueous solutions, anionic aliphatic surfactant, sodium dodecyl sulfate (SDS), cyclic lipopeptide biosurfactant, surfactin, water-soluble polymers, carboxyl methyl cellulose, hydroxyl ethyl cellulose, poly(vinyl alcohol), PVA, sodium dodecyl sulfate, SDS, n-methylpyrrolidone, polyoxyethylene surfactant, poly(vinylidene fluoride), PVDF, carboxyl methyl cellulose (CMC), hydroxyl ethyl cellulose (HEC), polyacrylic acid (PAA), polyvinyl chloride (PVC) and combinations thereof such that the dispersant is stable at voltages about 4.4 volts.
